(19) United States
(12) Patent Application Publication
(10) Pub. No.: US 2019/0235312 A1
(43) Pub. Date: Aug. 1, 2019

(54) LIQUID CRYSTAL LENS AND MANUFACTURING METHOD THEREOF, AND DISPLAY DEVICE

(71) Applicant: BOE Technology Group Co., Ltd., Beijing (CN)

(72) Inventors: Zheng Fang, Beijing (CN); Yunsik Im, Beijing (CN)

(73) Assignee: BOE Technology Group Co., Ltd.

(21) Appl. No.: 16/145,479

(22) Filed: Sep. 28, 2018

(30) Foreign Application Priority Data
Jan. 31, 2018 (CN) 201810097403.0

(51) Int. Cl. G02F 1/1335; G02F 1/1343

(52) U.S. Cl. CPC G02F 1/133526; G02F 1/134309

(57) ABSTRACT

A liquid crystal lens, a manufacturing method thereof, and a display device are provided. The liquid crystal lens includes a first substrate and a second substrate, the first substrate and the second substrate are opposite. A plurality of lens units are provided between the first substrate and the second substrate, the plurality of lens units are arranged in a matrix, and each of the plurality of lens units has a semispherical structure under the effect of an externally applied voltage and is used to control an angle of light perpendicular to the first substrate to enable the light perpendicular to the first substrate deflected towards a plurality of directions parallel to the first substrate. The liquid crystal lens raises the light utilization ratio and the display effect of the display device.

This application claims priority to the Chinese Patent Application No. 201810097403.0, filed on Jan. 31, 2018 and titled “LIQUID CRYSTAL LENS AND MANUFACTURING METHOD THEREOF, AND DISPLAY DEVICE”, the disclosure of which are incorporated herein by reference in its entirety.

### TECHNICAL FIELD

The present disclosure relates to a liquid crystal lens, a manufacturing method thereof, and a display device.

### BACKGROUND

As an important component of a display device, a liquid crystal lens has the advantages of small size, light weight, low power consumption and the like. Through the development in recent years, the liquid crystal lens has significant potential application value in the display field.

### SUMMARY

The disclosure provides a liquid crystal lens, a manufacturing method thereof, and a display device.

In an aspect, there is provided a liquid crystal lens, comprising: a first substrate and a second substrate, wherein the first substrate and the second substrate are opposite, a plurality of lens units are provided between the first substrate and the second substrate, the plurality of lens units are arranged in a matrix, and each of the plurality of lens units presenting a semispherical structure under the effect of an externally applied voltage and is used to control an angle of light perpendicular to the first substrate to enable the light perpendicular to the first substrate deflected towards a plurality of directions parallel to the first substrate.

Optionally, each of the plurality of lens units comprises a first electrode, a second electrode and a liquid crystal layer between the first electrode and the second electrode, the first electrode is disposed on the first substrate, and the second electrode is disposed on the second substrate; a protection of a center of the first electrode on the second substrate overlaps with a projection of a center of the second electrode on the second substrate, and a contact area between the first electrode and the first substrate is less than a contact area between the second electrode and the second substrate.

Optionally, the first electrode is a spot electrode.

Optionally, the second electrode is a circular electrode.

Optionally, the second electrode is a square electrode.

Optionally, the first electrode and the second electrode both have a thickness of 0.07 μm.

Optionally, the first electrode is made of indium tin oxide (ITO).

Optionally, the second electrode is made of ITO.

In another aspect, there is provided a method for manufacturing a liquid crystal lens, comprising:

forming a first thin film on a first substrate by sputtering;

performing a patterning process on the first substrate where the first thin film is formed to form a first electrode layer, the first electrode layer comprising a plurality of first electrodes, the plurality of first electrodes being arranged in a matrix;

forming a second thin film on a second substrate by sputtering;

performing a patterning process on the second substrate where the second thin film is formed to form a second electrode layer, the second electrode layer comprising a plurality of second electrodes, and the plurality of second electrodes having one-to-one correspondence with the plurality of first electrodes, for each pair of the first electrode and the second electrode, a projection of a center of the first electrode on the second substrate overlapping with a projection of a center of the second electrode on the second substrate, and a contact area between the first electrode and the first substrate being less than a contact area between the second electrode and the second substrate;

cell-aligning the first substrate and the second substrate; and

dropping liquid crystal between each pair of the first electrode and the second electrode to form a lens unit which has a semispherical structure under the effect of an externally applied voltage, and is used to control an angle of light perpendicular to the first substrate to enable the light perpendicular to the first substrate deflected towards a plurality of directions parallel to the first substrate.

In yet another aspect, there is provided a display device, comprising a liquid crystal lens, wherein the liquid crystal lens comprises: a first substrate and a second substrate, the first substrate and the second substrate are opposite; a plurality of lens units are provided between the first substrate and the second substrate, the plurality of lens units are arranged in a matrix, and each of the plurality of lens units has a semispherical structure under the effect of an externally applied voltage and is used to control an angle of light perpendicular to the first substrate to enable the light perpendicular to the first substrate deflected towards a plurality of directions parallel to the first substrate.

Optionally, each of the plurality of lens units comprises a first electrode, a second electrode and a liquid crystal layer between the first electrode and the second electrode, the first electrode is disposed on the first substrate, and the second electrode is disposed on the second substrate; a protection of a center of the first electrode on the second substrate overlaps with a projection of a center of the second electrode on the second substrate, and a contact area between the first electrode and the first substrate is less than a contact area between the second electrode and the second substrate.

Optionally, the first electrode is a spot electrode.

Optionally, the second electrode is a circular electrode.

Optionally, the second electrode is a square electrode.

Optionally, the first electrode and the second electrode both have a thickness of 0.07 μm.

Optionally, the first electrode is made of indium tin oxide (ITO).

Optionally, the second electrode is made of ITO

### BRIEF DESCRIPTION OF THE DRAWINGS

FIG. 1 is a schematic diagram of a structure of a liquid crystal lens that is already known to the inventors;

FIG. 2 is a schematic diagram of an equivalent model of the liquid crystal lens in FIG. 1 under the effect of an externally applied voltage;

FIG. 3 is a schematic diagram of a structure of a liquid crystal lens according to an embodiment of the present disclosure;

FIG. 4 is a schematic diagram of an equivalent model of the liquid crystal lens in FIG. 3 under the effect of an externally applied voltage;

FIG. 5 is a schematic diagram of a structure of a lens unit according to an embodiment of the present disclosure;

FIG. 6 is a top view of the lens unit in FIG. 5;

FIG. 7 is a schematic diagram of a lens unit under the effect of an externally applied voltage;

FIG. 8 is a top view of the lens unit in FIG. 7;

FIG. 9 is a schematic diagram of light deflection on an xy plane when a liquid crystal lens controls an angle of light perpendicular to a first substrate according to an embodiment of the present disclosure;

FIG. 10 is a schematic diagram of light deflection on an xy plane when a liquid crystal lens that is known to the inventors controls an angle of light perpendicular to a first substrate;

FIG. 11 is a schematic diagram of light deflection on a yz plane when a liquid crystal lens controls an angle of light perpendicular to a first substrate according to an embodiment of the present disclosure;

FIG. 12 is a schematic diagram of light deflection on a yz plane when a liquid crystal lens that is known to the inventors controls an angle of light perpendicular to a first substrate;

FIG. 13 is a diagram illustrating comparison between light intensities in a z-axis direction after light passes through a liquid crystal lens according to an embodiment of the present disclosure and through a liquid crystal lens that is known to the inventors;

FIG. 14 is a flowchart of a method for manufacturing a liquid crystal lens according to an embodiment of the present disclosure;

FIG. 15 is a structural schematic diagram of a first electrode layer according to an embodiment of the present disclosure;

FIG. 16 is a structural schematic diagram of a second electrode layer according to an embodiment of the present disclosure; and

FIG. 17 is a schematic structural diagram of cell-aligning a first substrate and a second substrate according to an embodiment of the present disclosure.

### DETAILED DESCRIPTION

The present disclosure will be described in further detail with reference to the drawings, to clearly present the principles and advantages of the present disclosure.

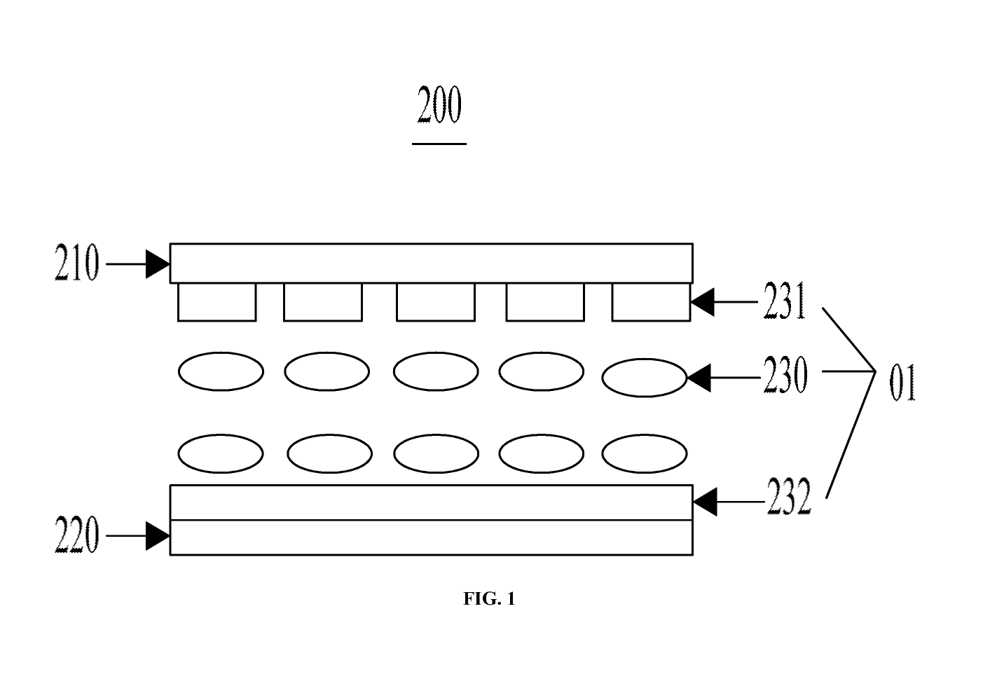

FIG. 1 is a schematic diagram of a structure of a liquid crystal lens 200 that is known to the inventors. The liquid crystal lens 200 includes a first substrate 210 and a second substrate 220. A plurality of lens units 01 are arranged between the first substrate 210 and the second substrate 220. Each of the plurality of lens units includes a first electrode 231, a second electrode 232 and a liquid crystal layer arranged between the first electrode 231 and the second electrode 232. The first electrode is a strip-shaped electrode, and the second electrode is a surface-shaped electrode.

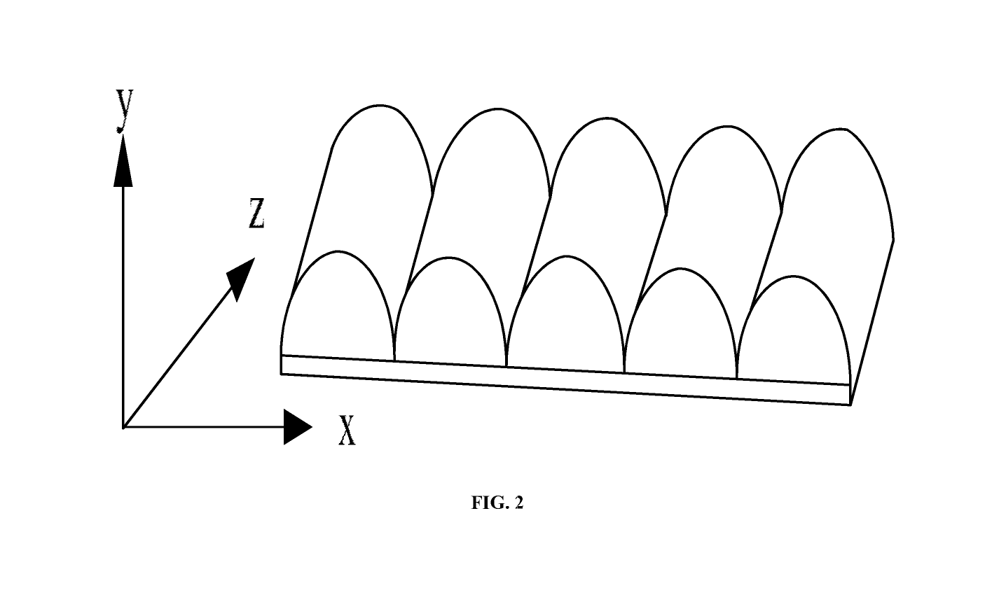

FIG. 2 is a schematic diagram of an equivalent model of the liquid crystal lens as illustrated in FIG. 1 under the effect of an externally applied voltage. Each of the plurality of lens units presents a column-shaped structure under the effect of the externally applied voltage. These column-shaped structures merely cause light perpendicular to the first substrate to be deflected towards an x-axis direction. Therefore, the light utilization ratio is low, and thus the display effect of a display device is affected.

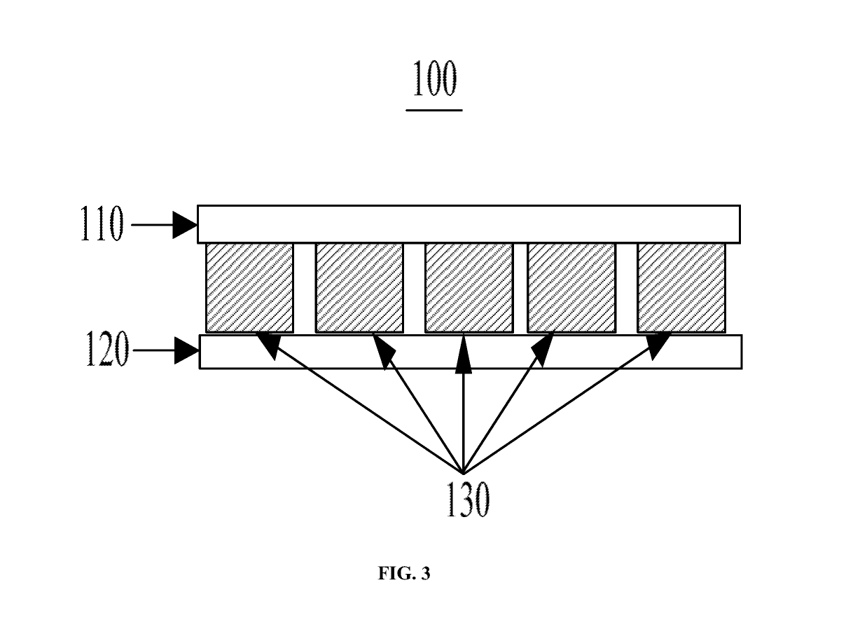

FIG. 3 is a schematic view of a structure of a liquid crystal lens 100 according to an embodiment of the present disclosure. The liquid crystal lens 100 includes a first substrate 110 and a second substrate 120. The first substrate 110 and the second substrate 120 are arranged to be opposite to each other. The first substrate and the second substrate are transparent substrates. For example, the first substrate and the second substrate may be glass substrates.

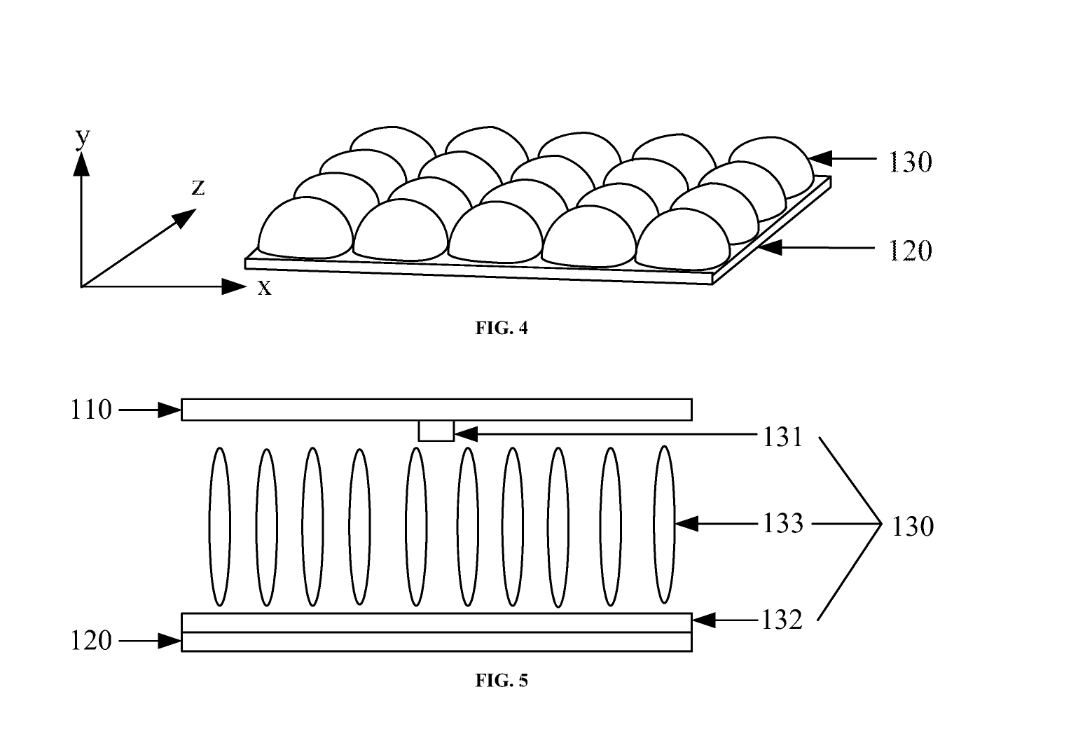

There are a plurality of lens units 130 between the first substrate 110 and the second substrate 120. The plurality of lens units 130 are arranged in a matrix. FIG. 4 is a schematic diagram of an equivalent model the liquid crystal lens under the effect of an externally applied voltage. As illustrated in FIG. 4, each of the plurality of lens units 130 presents a semispherical structure under the effect of the externally applied voltage, and is configured to control the angle of light perpendicular to the first substrate (that is, light perpendicularly incident onto the liquid crystal lens), such that the light perpendicular to the first substrate is deflected towards a plurality of directions parallel to the first substrate. The plurality of directions includes an x-axis direction and a z-axis direction. Herein, the x-axis direction includes an x-axis positive direction and an x-axis negative direction, and the z-axis direction includes a z-axis positive direction and a z-axis negative direction. The plurality of directions further includes directions parallel to the xz plane other than the x-axis direction and the z-axis direction. In FIG. 4, the substrate surface of the second substrate 120 is parallel to the substrate surface of the first substrate.

In the liquid crystal lens according to the embodiments of the present disclosure, a plurality of lens units arranged in a matrix are provided between the first substrate and the second substrate, and each of the plurality of lens units presents a semispherical structure under the effect of the externally applied voltage. As illustrated in FIG. 4, the liquid crystal lens can not only deflect the light perpendicular to the first substrate in the x-axis direction, but also deflect the light perpendicular to the first substrate towards other directions parallel to the first substrate, such as the z-axis direction. Therefore, the light utilization ratio is raised, and the display effect of the display device is enhanced.

FIG. 5 is a schematic diagram of a structure of a lens unit. As illustrated in FIG. 5, each lens unit 130 includes a first electrode 131, a second electrode 132 and a liquid crystal layer 133 between the first electrode and the second electrode. The first electrode 131 is located on the first substrate 110, and the second electrode 132 is located on the second substrate 120. The projection of the center of the first electrode 131 on the second substrate 120 overlaps with the projection of the center of the second electrode 132 on the second substrate 120. The contact area between the first electrode 131 and the first substrate 110 is less than the contact area between the second electrode 132 and the second substrate 120. Optionally, the first electrode may be a spot electrode. The liquid crystal included in the liquid crystal layer may be positive liquid crystal. In the case of no applied voltage, the long-axis direction of the liquid crystal molecules is perpendicular to the substrate surface of the first substrate.

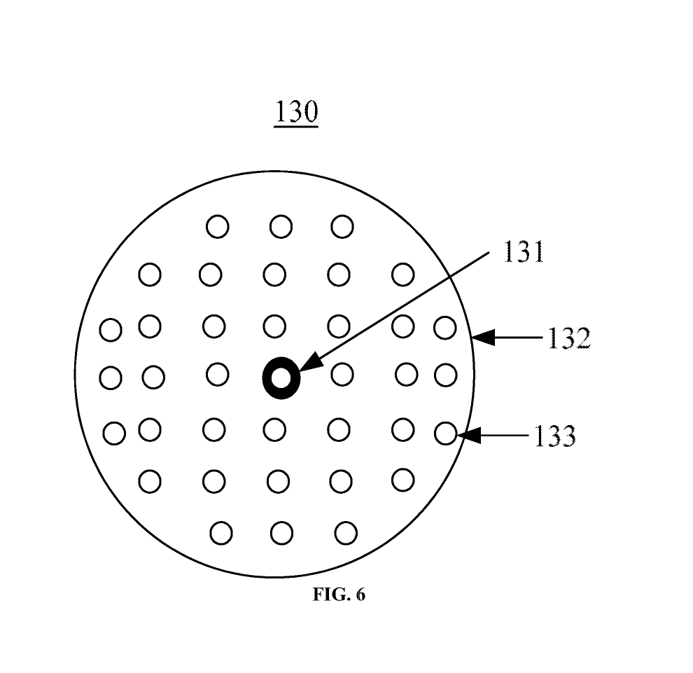

FIG. 6 is a top view of the lens unit 130 as illustrated in FIG. 5. As illustrated in FIG. 6, each lens unit 130 includes a first electrode 131, a second electrode 132 and a liquid crystal layer 133 between the first electrode 131 and the second electrode 132. The long-axis direction of the liquid crystal molecules is perpendicular to the substrate surface of the first substrate.

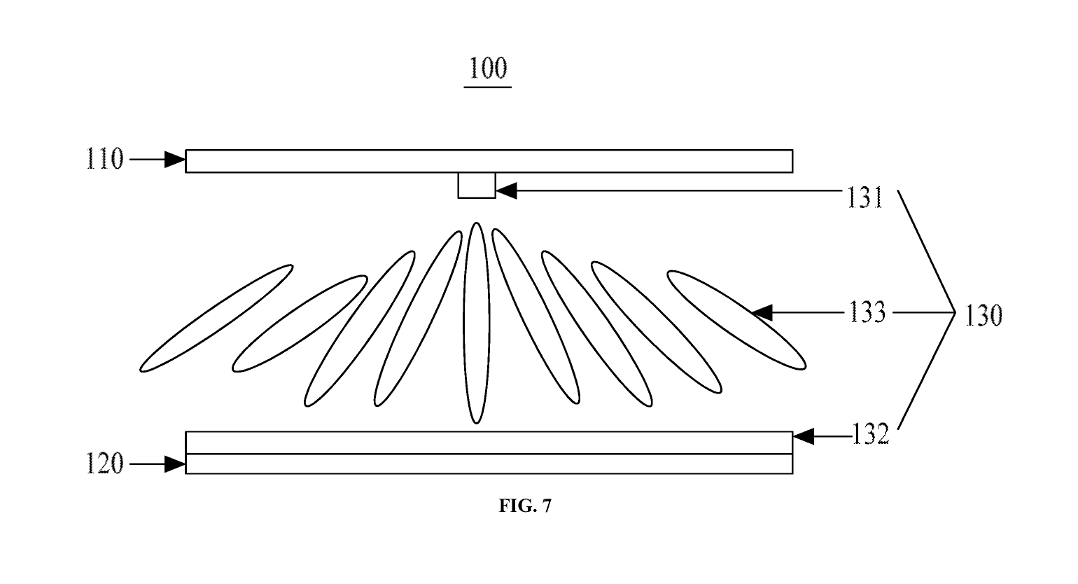

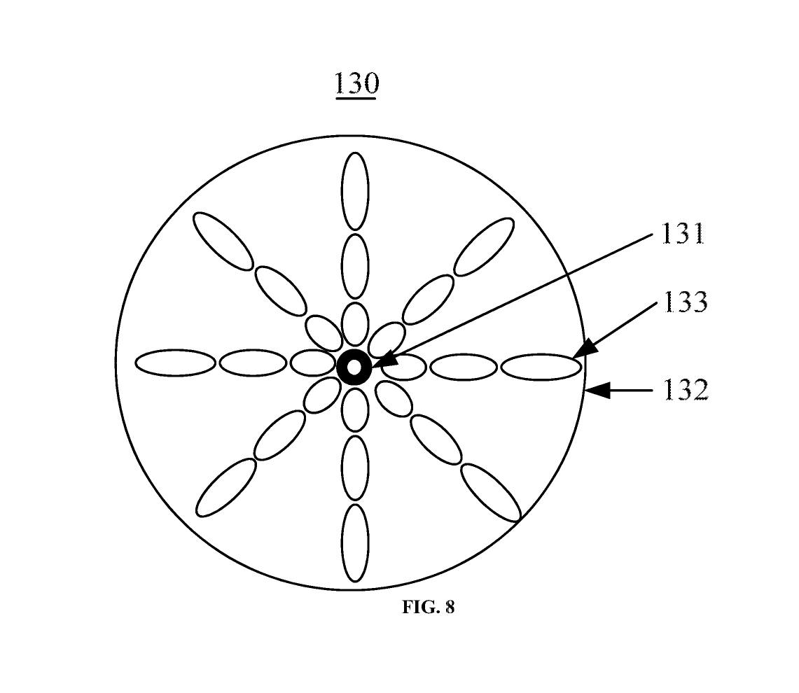

FIG. 7 is a schematic view of the lens unit in FIG. 5 under the effect of an externally applied voltage. As illustrated in FIG. 7, since the projection of the center of the first electrode 131 on the second substrate 120 overlaps with the projection of the center of the second electrode 132 on the second substrate 120, and the contact area between the first electrode 131 and the first substrate 110 is less than the contact area between the second electrode 132 and the second substrate 120, the liquid crystal in the liquid crystal layer 133 aggregates towards the center of the first electrode 131 with the center of the first electrode 131 as the center, under the effect of the externally applied voltage, such that each lens unit presents the semispherical structure. An equivalent model of the liquid crystal lens including the lens units is illustrated in FIG. 4. Therefore, the liquid crystal lens can not only deflect the light perpendicular to the first substrate in the x-axis direction, but also deflect the light perpendicular to the first substrate towards other directions parallel to the first substrate, such as the z-axis direction. Therefore, the light utilization ratio is improved.

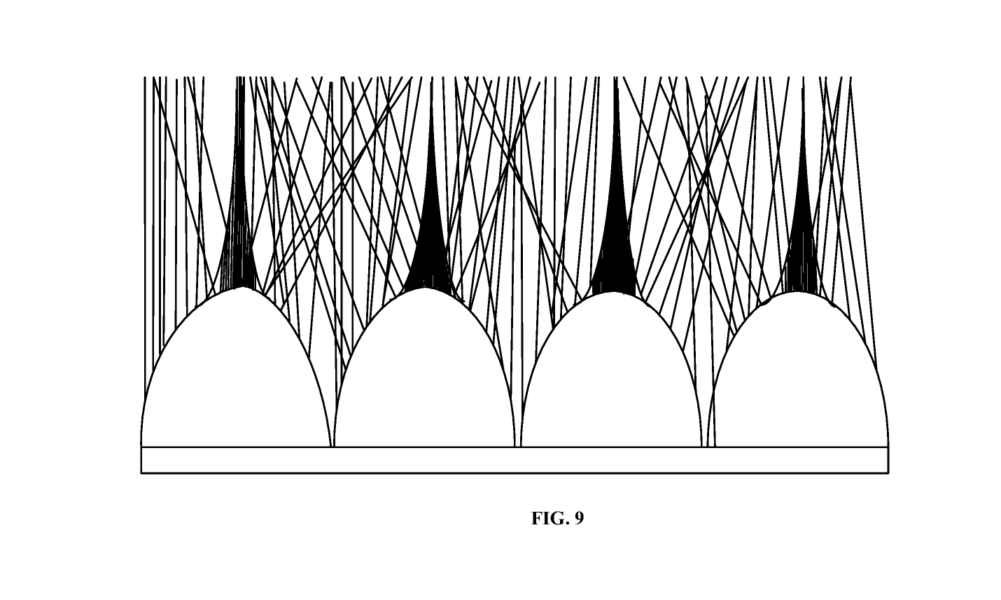

FIG. 8 is a top view of the lens unit 130 as illustrated in FIG. 7. As illustrated in FIG. 8, each lens unit 130 includes a first electrode 131, a second electrode 132 and a liquid crystal layer 133 between the first electrode 131 and the second electrode 132. The liquid crystal in the liquid crystal layer 133 aggregates towards the center of the first electrode 131.

Exemplarily, the semispherical structure presented by the lens unit under the effect of the externally applied voltage according to the embodiments of the present disclosure may be as illustrated in FIG. 4. The semispherical structure is a regular semispherical structure. In addition, the semispherical structure presented by the lens unit under the effect of the externally applied voltage may also be an irregular semispherical structure. Compared with the irregular semispherical structure, the regular semispherical structure enables the display luminance of the display device to be more uniform, and the regular semispherical structure achieves a better control effect on the angle of the light perpendicular to the first substrate.

Exemplarily, when the semispherical structure presented by the lens unit under the effect of the externally applied voltage is a regular semispherical structure, the first electrode may be a spot electrode, and the second electrode may be a circular electrode.

Exemplarily, when the semispherical structure presented by the lens unit under the effect of the externally applied voltage is an irregular semispherical structure, the first electrode may be a spot electrode, and the second electrode may be a square electrode.

Exemplarily, the first electrode and the second electrode may be made of indium tin oxide (ITO). The first electrode and the second electrode may both have a thickness of 0.07 μm.

In the embodiments of the present disclosure, the driving voltage for the first electrode and the second electrode may be 10 V.

In the embodiments of the present disclosure, the liquid crystal in the liquid crystal layer may be negative liquid crystal, which is not limited in the embodiments of the present disclosure.

In the embodiments of the present disclosure, the liquid crystal lens is marked as A1, and the liquid crystal lens illustrated in FIG. 1 that is known to the inventors is marked as A2. The case where the liquid crystal lens A1 and the liquid crystal lens A2 control the angle of the light perpendicular to the first substrate is tested, respectively. The test results are shown in FIG. 9 to FIG. 12. The comparison diagrams of the effects of controlling the angle of the light perpendicular to the first substrate by the liquid crystal lens A1 and the liquid crystal lens A2 are illustrated in FIG. 9 to FIG. 12.

Specifically, FIG. 9 is a schematic diagram of light deflection on an xy plane when the liquid crystal lens A1 controls the angle of the light perpendicular to the first substrate. The xy plane is a plane perpendicular to the first substrate, as illustrated in FIG. 4.

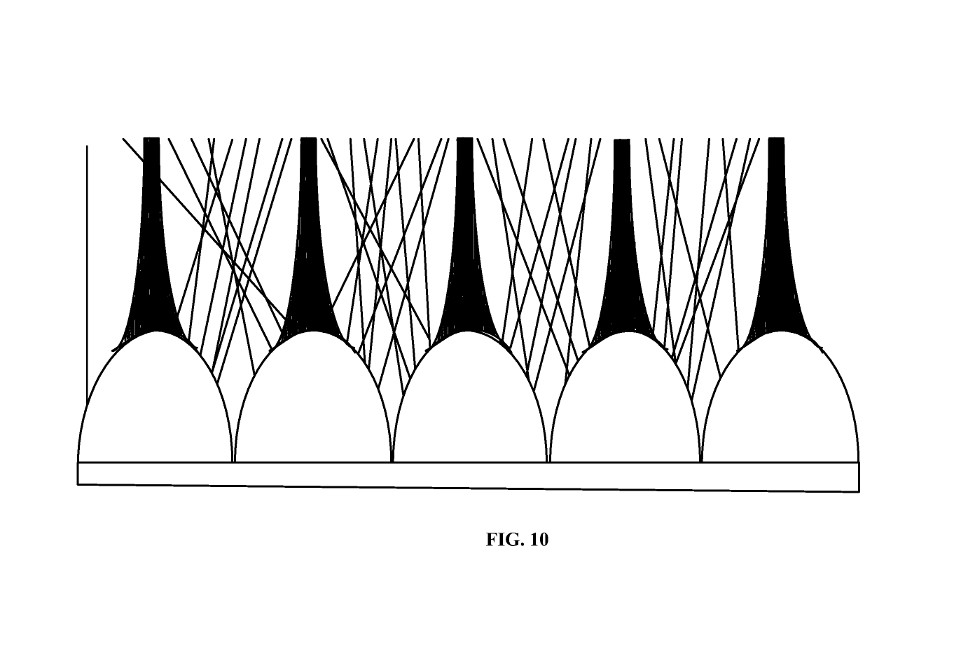

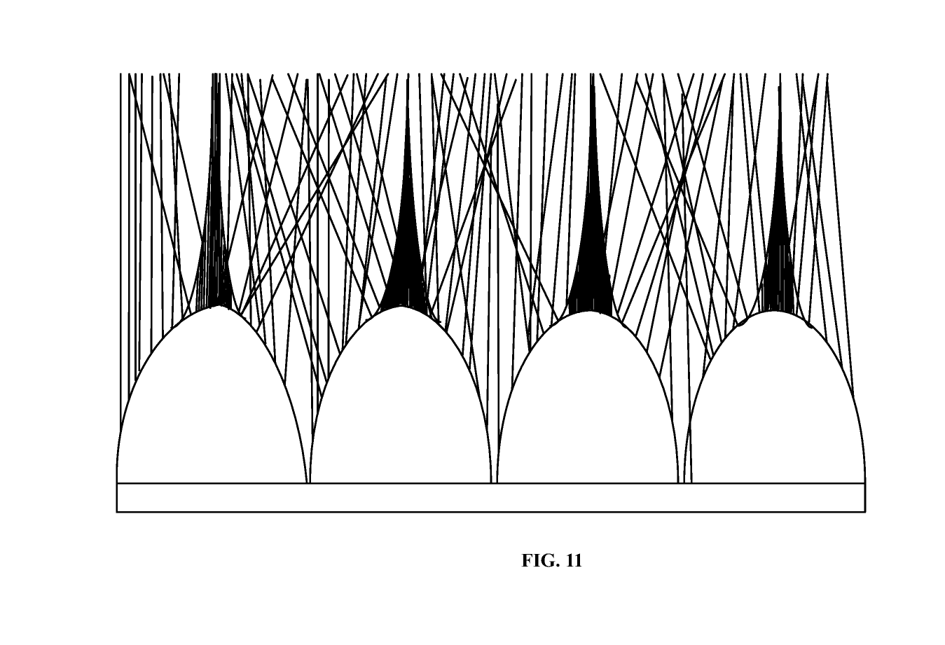

FIG. 10 is a schematic diagram of light deflection on the xy plane when the liquid crystal lens A2 controls the angle of the light perpendicular to the first substrate.

As seen from FIG. 9 and FIG. 10 that the light on the xy plane is deflected towards the x-axis direction no matter the angle of the light perpendicular to the first substrate is controlled by the liquid crystal lens A1 provided in the embodiments of the present disclosure or by the liquid crystal lens A2 known to the inventors.

FIG. 11 is a schematic diagram of light deflection on a yz plane when the liquid crystal lens A1 controls the angle of the light perpendicular to the first substrate. The yz plane is a plane perpendicular to the first substrate, as illustrated in FIG. 4.

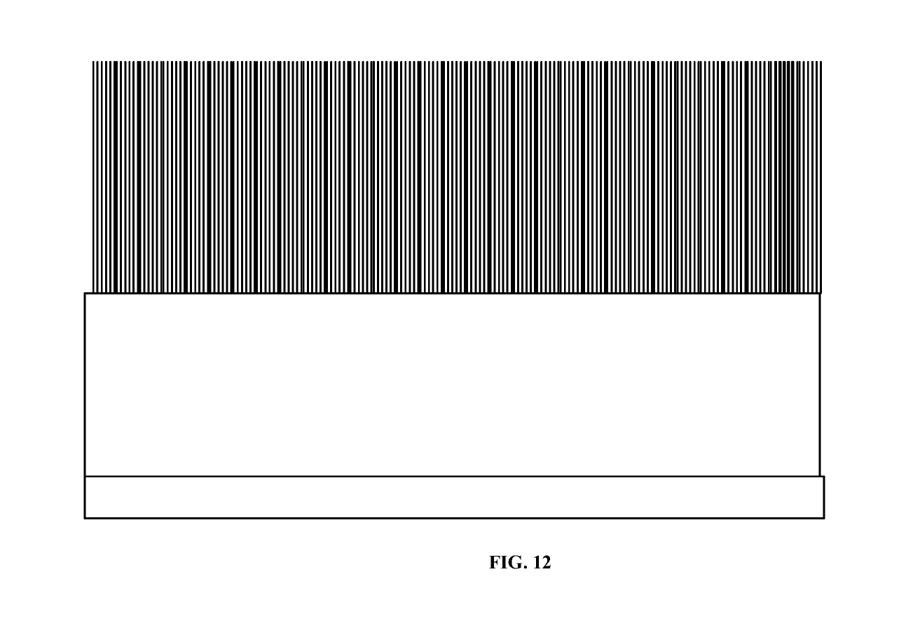

FIG. 12 is a schematic diagram of light deflection on the yz plane when the liquid crystal lens A2 controls the angle of the light perpendicular to the first substrate.

As seen from FIG. 11 and FIG. 12 that light on the yz plane may be deflected towards the z-axis direction when the angle of the light perpendicular to the first substrate is controlled by the liquid crystal lens A1 provided in the embodiment of the present disclosure, while light on the yz plane may not be deflected towards the z-axis direction the angle of the light perpendicular to the first substrate is controlled by when the liquid crystal lens A2 known to the inventors.

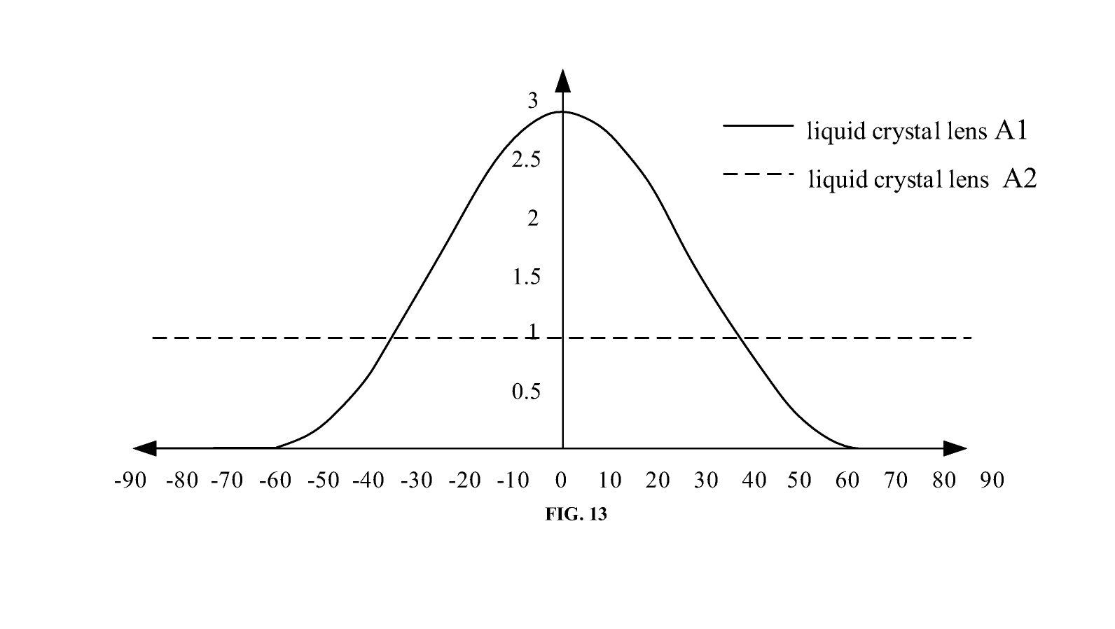

In addition, in the embodiments of the present disclosure, after the light perpendicular to the first substrate passes through the liquid crystal lens A1 and the liquid crystal lens A2, the light intensity of the light in the z-axis direction (refer to FIG. 2 and FIG. 4) is tested. The test result is as illustrated in FIG. 13. In FIG. 13, the horizontal coordinate denotes an included angle between light and the z-axis direction, and the longitudinal coordinate denotes the light intensity. The solid line shows the light intensity of the light in the z-axis direction after the light passes through the liquid crystal lens A1. The dotted line denotes the light intensity of the light in the z-axis direction after the light passes through the liquid crystal lens A2.

As seen from FIG. 13, after the light perpendicular to the first substrate passes through the liquid crystal lens A1, the light intensity of the light in the z-axis direction varies, while after the light passes through the liquid crystal lens A2, the light intensity of the light in the z-axis direction does not vary. Therefore, the liquid crystal lens A1 according to the embodiments of the present disclosure enables the light perpendicular to the first substrate to be deflected towards the z-axis direction, while the liquid crystal lens A2 known to the inventors fails to enable the light perpendicular to the first substrate to be deflected towards the z-axis direction.

In addition, according to embodiments of the present disclosure, the light utilization ratio of the liquid crystal lens A1 in the embodiments of the present disclosure and the light utilization ratio of the liquid crystal lens A2 known to the inventors are tested by using a light source with a light intensity of 10 nit. The test result is as follows: the light intensity of the light received by the liquid crystal lens A1 in the embodiments of the present disclosure is 8.6 nit, and the intensity of the light received by the liquid crystal lens A2 is 7.2 nit. Thus, compared with the liquid crystal lens A2 known to the inventors, the liquid crystal lens A1 according to the embodiments of the present disclosure has a higher light utilization ratio.

In summary, in the liquid crystal lens according to the embodiments of the present disclosure, a plurality of lens units arranged in a matrix are provided between the first substrate and the second substrate. Each of the plurality of lens unit presents a semispherical structure under the effect of an externally applied voltage, and is configured to control an angle of light perpendicular to the first substrate such that the light perpendicular to the first substrate is deflected towards a plurality of directions parallel to the first substrate. The liquid crystal lens can not only deflect the light perpendicular to the first substrate towards the x-axis direction, but also deflect the light perpendicular to the first substrate towards other directions parallel to the first substrate, such as the z-axis direction. Therefore, the light utilization ratio is improved, and the display effect of the display device is enhanced.

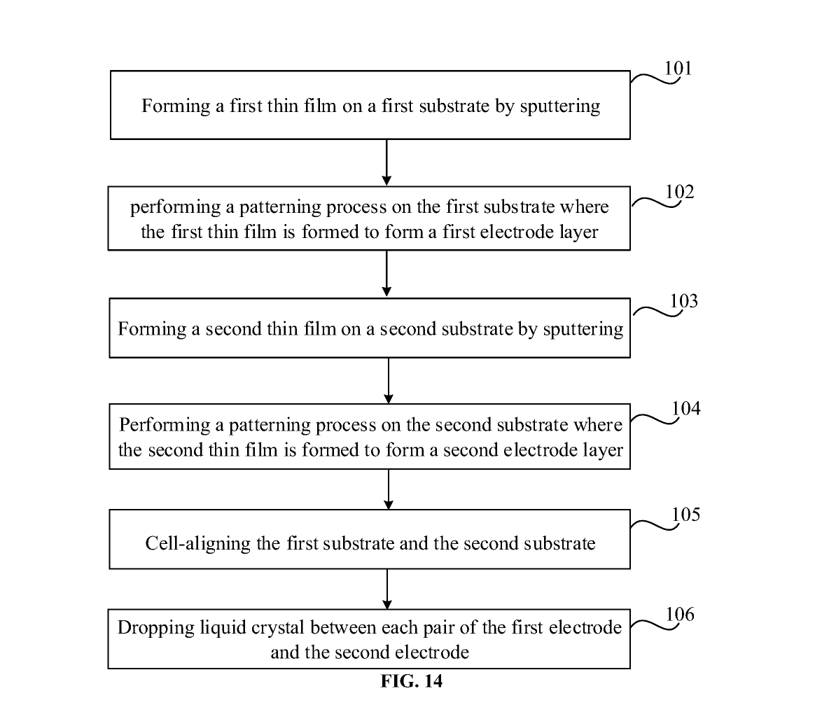

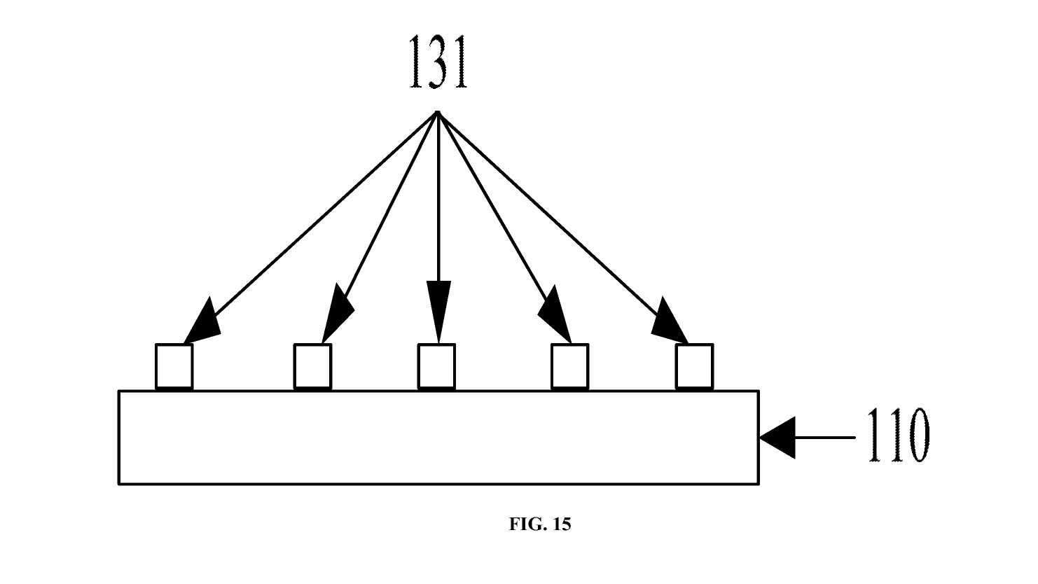

FIG. 14 is a flowchart of a method for manufacturing a liquid crystal lens according to an embodiment of the present disclosure. As illustrated in FIG. 14, the method includes the following steps.

In step 101, a first thin film is formed on a first substrate by sputtering.

Exemplarily, in step 101, the first thin film may also be formed on the first substrate by deposition, coating or the like.

In step 102, a patterning process is performed on the first substrate where the first thin film is formed, to form a first electrode layer.

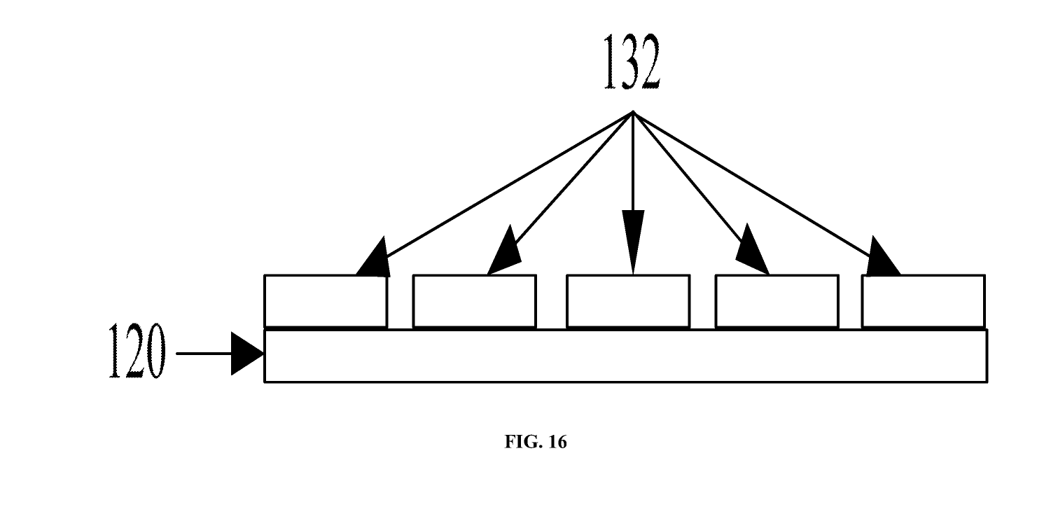

FIG. 15 is a schematic diagram of a structure of a formed first electrode layer according to an embodiment of the present disclosure. As illustrated in FIG. 15, the patterning process is performed on the first substrate 110 where the first thin film is formed, to form the first electrode layer. The first electrode layer includes a plurality of first electrodes 131 arranged in a matrix. Herein, the single patterning process includes photoresist coating, exposure, development, etching, photoresist stripping and the like.

In step 103, a second thin film is formed on a second substrate by sputtering.

In step 104, a patterning process is performed on the second substrate where the second thin film is formed, to form a second electrode layer.

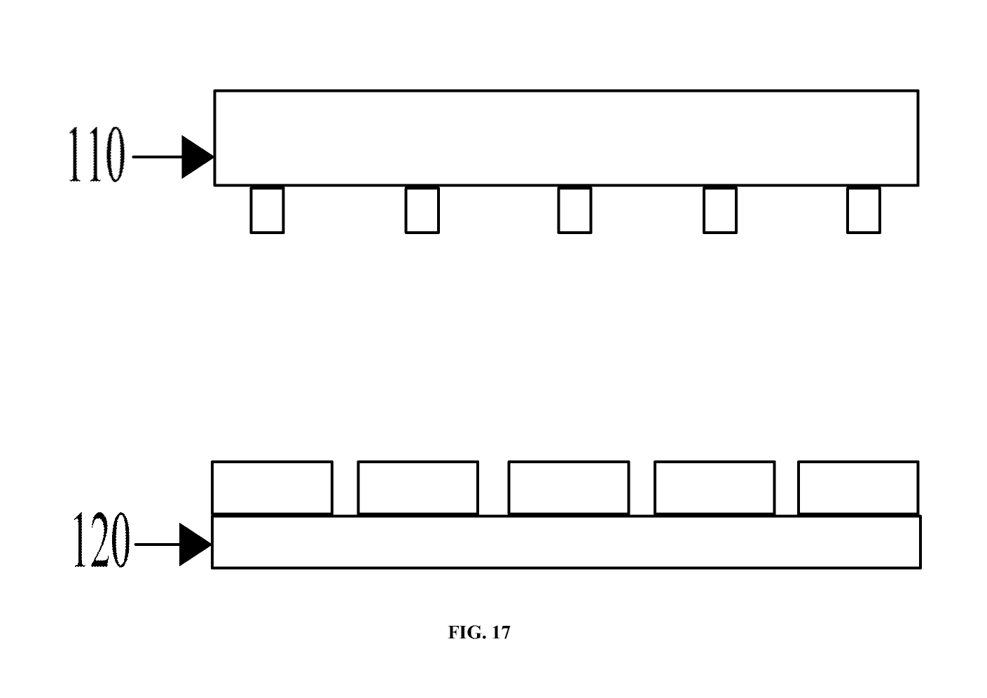

FIG. 16 is a structural schematic diagram of a formed second electrode layer according to an embodiment of the present disclosure. As illustrated in FIG. 16, the patterning process is performed on the second substrate 120 where the second thin film is formed, to form the second electrode layer. The second electrode layer includes a plurality of second electrodes 132 having one-to-one correspondence with the plurality of first electrodes. Still referring to FIG. 5, with respect to each pair of the first electrode 131 and the second electrode 132, the projection of the center of the first electrode 131 on the second substrate 120 overlaps with the projection of the center of the second electrode 132 on the second substrate 120, and the contact area between the first electrode and the first substrate is less than the contact area between the second electrode and the second substrate.

In step 105, the first substrate and the second substrate are cell-aligned.

FIG. 17 is a schematic diagram of a structure of cell-aligning the first substrate and the second substrate according to an embodiment of the present disclosure. As illustrated in FIG. 17, the first substrate 110 and the second substrate 120 are cell-aligned.

In step 106, liquid crystal is dropped between each pair of the first electrode and the second electrode.

The lens unit is formed by dropping the liquid crystal between each pair of the first electrode and the second electrode. The lens unit presents a semispherical structure under the effect of an externally applied voltage, and is configured to control the angle of light perpendicular to the first substrate such that the light perpendicular to the first substrate is deflected towards a plurality of directions parallel to the first substrate. Exemplarily, the liquid crystal may be positive liquid crystal, and may also be negative liquid crystal, which is not limited in the embodiments of the present disclosure.

The sequence of steps in the method for manufacturing a liquid crystal lens according to the embodiments of the present disclosure may be adjusted appropriately, and the steps may also be reduced or added based on circumstances. Within the technical scope of the present disclosure, any variations of the method that may be readily derived by a person skilled in the art shall fall within the protection scope of the present disclosure, which is thus not described herein any further.

In summary, according to the manufacturing method for a liquid crystal lens in the embodiments of the present disclosure, a plurality of lens units arranged in a matrix are provided between the first substrate and the second substrate. Each of the plurality of lens unit presents a semispherical structure under the effect of an externally applied voltage, and is configured to control an angle of light perpendicular to the first substrate such that the light perpendicular to the first substrate is deflected towards a plurality of directions parallel to the first substrate. Thus, the liquid crystal lens manufactured with this method can not only deflect the light perpendicular to the first substrate in the x-axis direction, but also deflect the light perpendicular to the first substrate towards other directions parallel to the first substrate, such as the z-axis direction. Therefore, the light utilization ratio is raised, and the display effect of the display device is enhanced.

An embodiment of the present disclosure further provides a display device. The display device includes a liquid crystal lens, which may be the liquid crystal lens 100 illustrated in FIG. 3.

Herein, the display device may be any product or part with a display function, such as a mobile phone, a tablet computer, a TV, a display, a laptop computer, a digital photo frame, a navigator or the like.

In summary, a display device is provided in the embodiments of the present disclosure, and the display device includes a liquid crystal lens. A plurality of lens units arranged in a matrix are provided between the first substrate and the second substrate. Each of the plurality of lens unit presents a semispherical structure under the effect of an externally applied voltage, and is configured to control an angle of light perpendicular to the first substrate to enable the light perpendicular to the first substrate deflected towards a plurality of directions parallel to the first substrate. Thus, the liquid crystal lens can not only deflect the light perpendicular to the first substrate in the x-axis direction, but also deflect the light perpendicular to the first substrate towards other directions parallel to the first substrate, such as the z-axis direction. Therefore, the light utilization ratio is raised, and the display effect of the display device is enhanced.

Other embodiments of the present disclosure may be available to those skilled in the art upon consideration of the specification and practice of the present disclosure. The present disclosure is intended to cover any variations, uses, or adaptations of the present disclosure following general principles of the present disclosure and include the common general knowledge or conventional technical means in the art without departing from the present disclosure. The specification and examples may be shown as illustrative only, and the true scope and spirit of the present disclosure are indicated by the claims.

It should be understood that the present disclosure is not limited to the precise constructions described above and shown in the drawings, and various modifications and changes may be made without departing from the scope thereof. The scope of the present disclosure can be limited only by the appended claims.

What is claimed is:

1. A liquid crystal lens, comprising: a first substrate and a second substrate,
wherein the first substrate and the second substrate are opposite, a plurality of lens units are between the first substrate and the second substrate, the plurality of lens units are arranged in a matrix, and each of the plurality of lens units has a semispherical structure under the effect of an externally applied voltage and is used to control an angle of light perpendicular to the first substrate to enable the light perpendicular to the first substrate deflected towards a plurality of directions parallel to the first substrate.

2. The liquid crystal lens according to claim 1, wherein
each of the plurality of lens units comprises a first electrode, a second electrode and a liquid crystal layer between the first electrode and the second electrode, the first electrode is on the first substrate, and the second electrode is on the second substrate;
a protection of a center of the first electrode on the second substrate overlaps with a projection of a center of the second electrode on the second substrate, and a contact area between the first electrode and the first substrate is less than a contact area between the second electrode and the second substrate.

3. The liquid crystal lens according to claim 2, wherein the first electrode is a spot electrode.

4. The liquid crystal lens according to claim 2, wherein the second electrode is a circular electrode.

5. The liquid crystal lens according to claim 2, wherein the second electrode is a square electrode.

6. The liquid crystal lens according to claim 2, wherein the first electrode and the second electrode both have a thickness of 0.07 μm.

7. The liquid crystal lens according to claim 2, wherein the first electrode is made of indium tin oxide (ITO).

8. The liquid crystal lens according to claim 2, wherein the second electrode is made of ITO.

9. A method for manufacturing a liquid crystal lens, comprising:
forming a first thin film on a first substrate by sputtering;
performing a patterning process on the first substrate where the first thin film is formed, to form a first electrode layer, the first electrode layer comprising a plurality of first electrodes, the plurality of first electrodes being arranged in a matrix;
forming a second thin film on a second substrate by sputtering;
performing a patterning process on the second substrate where the second thin film is formed, to form a second electrode layer, the second electrode layer comprising a plurality of second electrodes, and the plurality of second electrodes having one-to-one correspondence with the plurality of first electrodes, for each pair of the first electrode and the second electrode, a projection of a center of the first electrode on the second substrate overlapping with a projection of a center of the second electrode on the second substrate, and a contact area between the first electrode and the first substrate being less than a contact area between the second electrode and the second substrate;
cell-aligning the first substrate and the second substrate; and
dropping liquid crystal between each pair of the first electrode and the second electrode to form a lens unit which has a semispherical structure under the effect of an externally applied voltage, and is used to control an angle of light perpendicular to the first substrate to enable the light perpendicular to the first substrate deflected towards a plurality of directions parallel to the first substrate.

10. A display device, comprising a liquid crystal lens,
wherein the liquid crystal lens comprises: a first substrate and a second substrate, the first substrate and the second substrate are opposite,
a plurality of lens units are between the first substrate and the second substrate, the plurality of lens units are arranged in a matrix, and each of the plurality of lens units has a semispherical structure under the effect of an externally applied voltage and is used to control an angle of light perpendicular to the first substrate to enable the light perpendicular to the first substrate deflected towards a plurality of directions parallel to the first substrate.

11. The display device according to claim 10, wherein
each of the plurality of lens units comprises a first electrode, a second electrode and a liquid crystal layer between the first electrode and the second electrode, the first electrode is on the first substrate, and the second electrode is on the second substrate;
a protection of a center of the first electrode on the second substrate overlaps with a projection of a center of the second electrode on the second substrate, and a contact area between the first electrode and the first substrate is less than a contact area between the second electrode and the second substrate.

12. The display device according to claim 11, wherein the first electrode is a spot electrode.

13. The display device according to claim 11, wherein the second electrode is a circular electrode.

14. The display device according to claim 11, wherein the second electrode is a square electrode.

15. The display device according to claim 11, wherein the first electrode and the second electrode both have a thickness of 0.07 μm.

16. The display device according to claim 11, wherein the first electrode is made of indium tin oxide (ITO).

17. The display device according to claim 11, wherein the second electrode is made of ITO.
